(19) United States
(12) Patent Application Publication
(10) Pub. No.: US 2016/0330914 A1
(43) Pub. Date: Nov. 17, 2016

(54) HEDGE TRIMMER

(71) Applicant: JENN FENG NEW ENERGY CO., LTD., Ping Chang City (TW)

(72) Inventor: Yung-Chun TANG, Ping Chang City (TW)

(73) Assignee: JENN FENG NEW ENERGY CO., LTD., Ping Chang City (TW)

(21) Appl. No.: 14/712,091

(22) Filed: May 14, 2015

(51) Int. Cl. A01G 3/053

(52) U.S. Cl. CPC A01G 3/053

(57) ABSTRACT

A hedge trimmer includes elongated upper and lower blades overlapping relative to each other, each of the blades including a trimming portion having an outer periphery formed with a plurality of trimming edges and a mounting portion formed with a guiding hole; upper and lower eccentric wheels that extend into the guiding holes of the blades and that is formed with an eccentric hole respectively; and a brushless motor including an output shaft extending into and operably coupled with the eccentric holes in the eccentric wheels such that activation of the motor results in rotation of the eccentric wheels within the guiding holes in the blades, thereby driving the blades reciprocally relative to each other along their longitudinal direction.

### BACKGROUND OF THE INVENTION

1. Field of the Invention

The present invention relates generally to a hedge trimmer, and more particularly to a hedge trimmer including a cutting device consisting of upper and lower blades which overlap relative to each other and which are movable reciprocally relative to each other along their longitudinal direction so as to cut off partial portion of a row of shrubs, bushes, or trees, simply a hedge.

2. The Prior Arts

A hedge trimmer is a tool for trimming bushes of gardens in order to provide decent looking of the gardens. A conventional hedge trimmer generally includes a motor and a gear system to reduce the rotation speed of an output shaft of the motor in order to provide high torque to upper and lower eccentric wheels for driving overlapping upper and lower blades to move reciprocally relative to each other along their longitudinal direction, thereby cutting off partial sections of the hedge or trees. Hence, the garden or hedge provides a more decent appearance when compared to manual trimming of the hedge.

Some disadvantages resulted from the conventional hedge trimmer resides in that:

I. The reduced rotation speed of the output shaft of the motor via the gear system lowers the efficiency of the motor.

II. The meshing of gear wheels in the gear system generates unfavorable noise.

III. Since the gear system occupies a relatively large space in the conventional hedge trimmer, the latter is bulky in size and cause large manufacturing expense.

IV. Since the rear end of the output shaft of the motor is disposed in a bearing unit, and since the latter is directly contact with the eccentric wheel, undesired heat and friction will be generated therebetween during operation of the conventional hedge trimmer, which sometimes hinder operation of the conventional hedge trimmer.

V. The motor chamber is hermetically sealed such that the heat generated due to activation of the motor cannot be dissipated to an exterior of the motor chamber such that the motor will be deactivated due to overheat.

Therefore, under the principle that without deploying the gear system when developing a hedge trimmer of the present invention, it is required to solve how to maintain the efficiency of the motor, eliminate the undesired noise and at the same time reduce the size, the manufacturing expense and to provide high heat dissipation effect are the presently existing problems to be solved.

### SUMMARY OF THE INVENTION

A primary objective of the present invention is to provide a hedge trimmer, which includes a brushless motor having an output shaft directly extending into and operably coupled with upper and lower eccentric holes in upper and lower eccentric wheels in order to drive upper and lower blades to move reciprocally relative to each other along their longitudinal direction. Hence no gear system is employed in the hedge trimmer of the present invention but the hedge trimmer can maintain the efficiency the motor, thereby reducing the noise effectively, the size and the manufacturing expense.

Another objective of the present invention is to provide a hedge trimmer, in which a washer is used to adjust the distance between one eccentric wheel and a bearing unit so as to avoid the problem of generation of overheat due to friction therebetween, thereby eliminating the overheat of the motor.

Yet another objective of the present invention is to provide a hedge trimmer, which includes a casing defining a motor chamber confined by a peripheral wall that is formed with a plurality of heat dissipation holes to enhance the heat dissipation effects.

One specific feature of the present invention is to provide a hedge trimmer that includes a cutting device, a cam mechanism and a brushless motor.

The cutting device includes elongated upper and lower blades disposed overlapping relative to each other. Each of the upper and lower blades includes a trimming portion having an outer periphery formed with a plurality of trimming edges and a mounting portion formed with a guiding hole.

The cam mechanism includes an upper eccentric wheel that extends into the guiding hole of the upper blade and that is formed with an eccentric hole, and a lower eccentric wheel that extends into the guiding hole of the lower blade and that is formed with an eccentric hole.

The brushless motor includes an output shaft extending into and operably coupled with the eccentric holes in the upper and lower eccentric wheels such that upon activation of the motor results in rotation of the upper and lower eccentric wheels within the guiding holes in the upper and lower blades, thereby driving the upper and lower blades reciprocally relative to each other along their longitudinal direction.

In one embodiment, the hedge trimmer of the present invention further includes a casing, a bearing unit and an extra washer. The casing encloses the mounting portions of the upper and lower blades, the upper and lower eccentric wheels and the brushless motor therein. The bearing unit is disposed at a bottom portion of the casing while the extra washer is sandwiched between the bearing unit and the lower eccentric wheel such that the output shaft extends through the extra washer and the bearing unit for operably coupled with the eccentric holes in the upper and lower eccentric wheels.

One specific feature of the present invention resides in that the motor and the gear system employed in the conventional hedge trimmer is replaced by the brushless motor in such a manner that the output shaft of the brushless motor extends directly and is operably coupled with the eccentric holes in the upper and lower eccentric wheels so as to drive the upper and lower blades, thereby reducing the noise, an overall size and maintaining the efficiency of the brushless motor. In addition, implementation of the washer between the lower eccentric wheel and the bearing unit prevents overheating of the brushless motor during long period of activation owing to reduced friction therebetween. Moreover, the casing defines a motor chamber for installation of the brushless motor therein and the peripheral wall confining the chamber is formed with a plurality of heat dissipation hole to dissipate the heat generated during operation of the motor.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a hedge trimmer of the present invention;

FIG. 2 is an exploded view the hedge trimmer of the present invention;

FIG. 3 shows a fragmentary top planar view of the hedge trimmer of the present invention, illustrating how upper and lower blades move reciprocally relative to each other along their longitudinal direction in first and second opposite directions; and

FIG. 4 shows a fragmentary top planar view of the hedge trimmer of the present invention, illustrating how upper and lower blades move reciprocally relative to each other along their longitudinal direction in first and second opposite directions from another angle.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

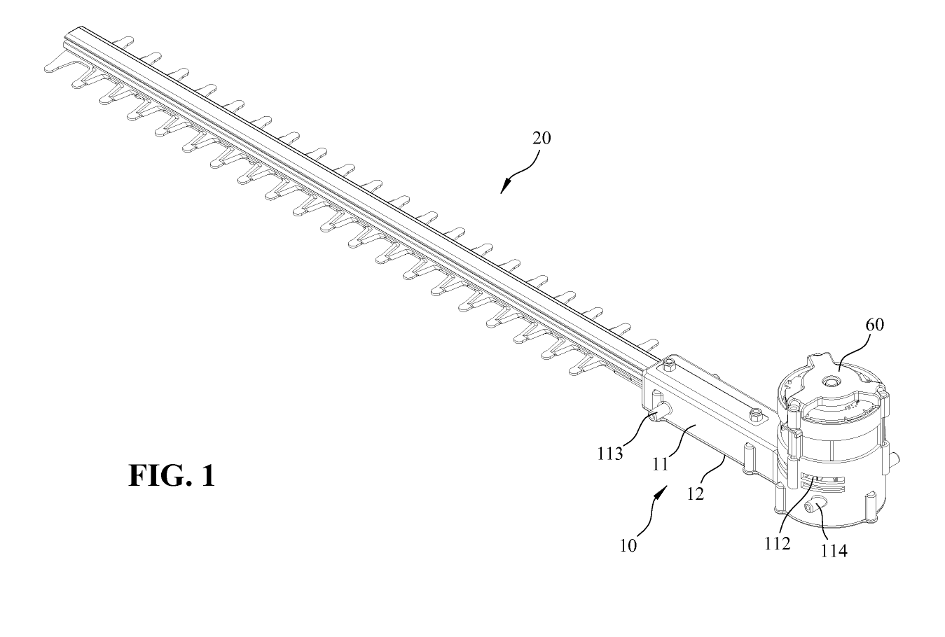

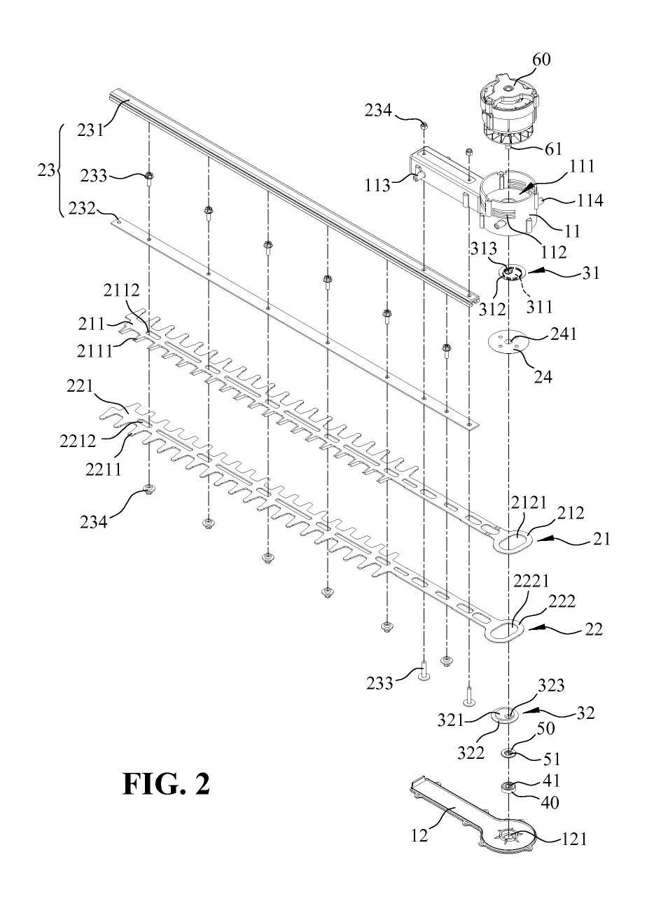

Referring to FIGS. 1 and 2, wherein, FIG. 1 is a perspective view of a hedge trimmer of the present invention while FIG. 2 is an exploded view the hedge trimmer of the present invention. As illustrated, the hedge trimmer of the present invention includes a casing 10, a cutting device 20, a cam mechanism, a bearing unit 40, a washer unit 50 and a brushless motor 60.

The casing 10 is constituted by upper and lower half casings 11, 12 which are coupled securely relative to each other. The upper half casing 11 defines a motor chamber 111 for receiving the brushless motor 60 therein. The motor chamber 111 has a peripheral wall confining the chamber and is formed with two heat dissipation holes 112. The upper half casing 11 further has a pair of front fixing studs 113, a pair of rear fixing studs 114 and a switch (not visible). The front and rear pairs of holding fixing studs 113, 114 are intended for the user to grip the same for manipulating the hedge trimmer of the present invention.

The cutting device 20 includes elongated upper and lower blades 21, 22 disposed in overlapping manner relative to each other, a blade guiding device 23 and a first washer 24. Each of the upper and lower blades 21, 22 includes a trimming portion 211 having an outer periphery formed with a plurality of trimming edges 2111, 2211 and a mounting portion 212, 222 formed with a guiding hole 2121, 2221. The casing 10 encloses the mounting portions 212, 222 of the upper and lower blades 21, 22 therein such that the guiding holes 2121, 2221 are aligned with each other while the trimming portions 211, 221 of the upper and lower blades 21, 22 are exposed outwardly and axially from the casing 10. Preferably, each of the guiding holes 2121, 2221 in each of the upper and lower blades 21, 22 is oval-shaped so as to possess a minor diameter extending in the longitudinal direction of the upper and lower blades 21, 22 and a major diameter transverse to the minor diameter. The blade guiding device 23 further includes an upper guiding plate 231 disposed above the upper blade 21, a lower guiding plate 232 sandwiched between the upper guiding plate 231 and the upper blade 21 such that the rear portions of the upper and lower guide plates 231, 232 are enclosed with the casing 10 while the front portion of the upper and lower guiding plates 231, 232 cover the middle sections of the upper and lower blades 21, 22 so as to expose the trimming edges 2111, 2211 to an exterior of the upper and lower guiding plates 231, 232. Two fastener screws 233 extend through the sliding slots 2112, 2212 in the upper and lower blades 21, 22 and fasten threadedly with two nuts 234 so as to mount the upper and lower guiding plates 231, 232 on the upper half casing 11 while the remaining fastener screws 233 extend through the other sliding slots in the upper and lower blades 21, 22 and the upper and lower guiding plates 231, 232 so as to fasten the nuts 234 threadedly such that the whole assembly is mounted on the upper half casing 11. Preferably, the first washer 24 is sandwiched between the mounting portions 212, 222 of the upper and lower blades 21, 22. Since the washer 24 is circular and has a washer hole 241 located at a central axis of the circular washer 24.

The cam mechanism is disposed within the casing 10, and includes an upper eccentric wheel 31 and a lower eccentric wheel 32 disposed respectively above and below the mounting portions 212, 222 of the upper and lower blades 21, 22. Each of the upper and lower eccentric wheels 31, 32 has an eccentric hole 313, 323, a circular narrow diameter section 311, 321 extending into the guiding holes 212, 222 in the upper and lower blades 21, 22 and a large diameter section 312, 322 having an outer diameter greater than the minor diameter of the guiding holes 212, 222 such that the large diameter sections 312, 322 cover the guiding holes 212, 222 in the upper and lower blades 21, 22 respectively from above and below while the eccentric holes 313, 323 extend through the narrow and large diameter sections 311, 321; 312, 322 of the upper and lower eccentric wheels 31, 32 offset to their common axis.

Preferably, the bearing unit 40 is disposed at a bottom portion of the casing 10. The bearing unit 40 is formed with a bearing hole 41, and is mounted in a bearing seat 121 formed in the lower half casing 12, which in fact is an elongated planar plate for covering the bottom part of the upper half casing 11, as best shown in FIG. 2, the purpose of which will be given in the following paragraphs.

Preferably, an extra washer 50 is sandwiched between the bearing unit 40 and the lower eccentric wheel 32 in order to reduce the friction therebetween upon operation of the hedge trimmer of the present invention. To be more specific, the extra washer 50 is formed with a central hole 51.

The brushless motor 60 is disposed in the motor chamber 111 in the upper half casing 11 and is electrically connected with the switch (not visible) for activating and de-activating the motor 60. The brushless motor 60 includes an output shaft 61 extending into and operably coupled with the eccentric holes 313, 323 in the upper and lower eccentric wheels 31, 32 via the washer holes 241, 51 in the washers 24, 50 and the hole 41 in the bearing unit 40. Since the structure of the brushless motor 60 is known in the art, a detailed description of the same is omitted herein for the sake of brevity.

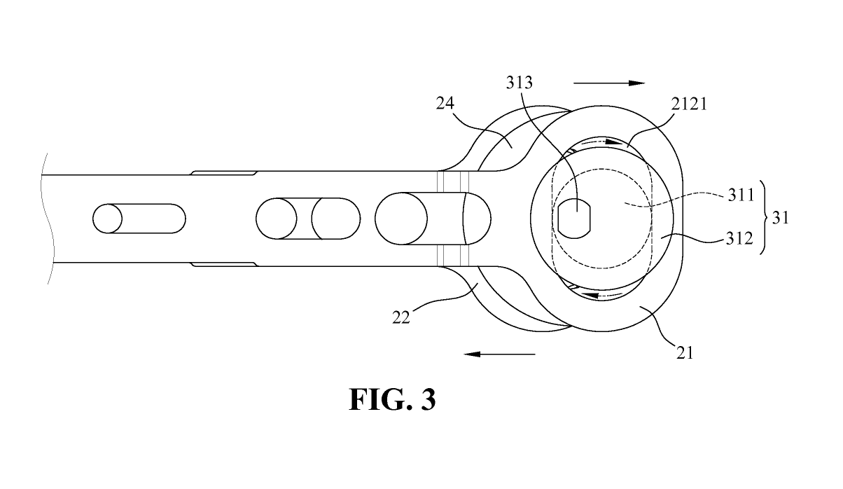

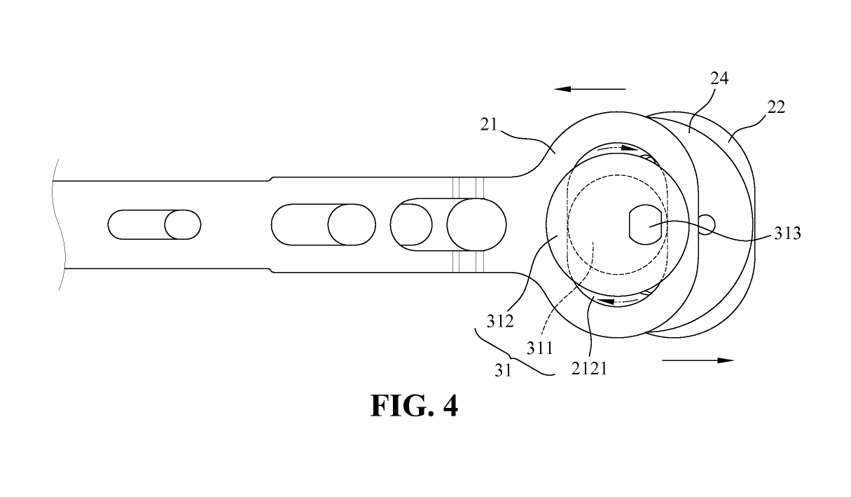

Referring to FIGS. 3 and 4, wherein FIG. 3 shows a fragmentary top planar view of the hedge trimmer of the present invention, illustrating how upper and lower blades 21, 22 move reciprocally relative to each other along their longitudinal direction in first and second opposite directions; and FIG. 4 shows a fragmentary top planar view of the hedge trimmer of the present invention, illustrating how upper and lower blades 21, 22 move reciprocally relative to each other along their longitudinal direction in first and second opposite directions from another angle. As illustrated, upon activation of the brushless motor 60, i.e., when the switch is switched on, the narrow diameter sections 311, 321 of the upper and lower eccentric wheels 31, 32 are driven to rotate within the oval-shaped guiding holes 2121, 2221 in the upper and lower blades 21, 22, thereby driving the upper and lower blades 21, 22 reciprocally relative to each other along their longitudinal direction owing to the minor diameter of the guiding hole 2121, 2221 being extending along the longitudinal direction of the blades 21, 22, hence trimming the bushes or hedge by the trimming edges 2111, 2211 is resulted.

The brushless motor 60 employed in the hedge trimmer of the present invention provides low noise, slow rotation speed with high torque as in the conventional gear system in addition to compact size and low manufacturing expense. Moreover, since the output shaft 61 of the brushless motor 60 is directly and operably coupled with the eccentric holes 313, 323 in the upper and lower eccentric wheels 31, 32, no gear system is required to reduce the rotation speed of the upper and lower eccentric wheels 31, 32. In other words, the assembly of conventional gear system and motor is replaced by a single brushless motor to perform the required activity in the present invention in order to enhance the efficiency of the hedge trimmer of the present invention.

In addition, placing the extra washer 50 between the lower eccentric wheel 32 and the bearing unit 40 can adjust the required distance therebetween so to avoid the problem of overheating the lower eccentric wheel 32 and the bearing unit 40 owing to long period operation of the motor 60.

The formation of heat dissipation holes 112 in the motor chamber 111 further enhance the heat dissipation effect of the brushless motor 60, thereby preventing overheating of the brushless motor 60.

Provision of the washer 24 between the mounting portions 212, 222 of the upper and lower blades 21, 22 reduces friction, but smooth sliding relative to each other when the upper and lower blades 21, 22 are driven reciprocally along their longitudinal direction.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A hedge trimmer comprising:
a cutting device including elongated upper and lower blades overlapping relative to each other, each of said upper and lower blades including a trimming portion having an outer periphery formed with a plurality of trimming edges and a mounting portion formed with a guiding hole;
a cam mechanism including an upper eccentric wheel that extends into said guiding hole of said upper blade and that is formed with an eccentric hole, and a lower eccentric wheel that extends into said guiding hole of said lower blade and that is formed with an eccentric hole; and
a brushless motor including an output shaft extending into and operably coupled with said eccentric holes in said upper and lower eccentric wheels such that activation of said motor results in rotation of said upper and lower eccentric wheels within said guiding holes in said upper and lower blades, thereby driving said upper and lower blades reciprocally relative to each other along their longitudinal direction.

2. The hedge trimmer according to claim 1, wherein said cutting device further includes a washer sandwiched between said mounting portions of said upper and lower blades, said washer having a washer hole permitting extension of said output shaft of said motor.

3. The hedge trimmer according to claim 2, wherein said washer hole is located at a central axis of said washer.

4. The hedge trimmer according to claim 1, wherein said guiding hole in each of said upper and lower blades is oval-shaped so as to possess a minor diameter extending in the longitudinal direction of said upper and lower blades and a major diameter transverse to said minor diameter.

5. The hedge trimmer according to claim 4, wherein said upper and lower eccentric wheels are disposed respectively above and below said upper and lower blades, each of said upper and lower eccentric wheels has a circular narrow diameter section extending into said guiding hole in said upper and lower blades and a large diameter section having an outer diameter greater than said minor diameter of said guiding hole such that said large diameter section covers said guiding hole in said upper and lower blades respectively from above and below while said eccentric holes extends through said narrow and large diameter sections of said upper and lower eccentric wheels.

6. The hedge trimmer according to claim 1, further comprising a casing enclosing said mounting portions of said upper and lower blades, said upper and lower eccentric wheels and said motor therein, a bearing unit disposed at a bottom portion of said casing and an extra washer sandwiched between said bearing unit and said lower eccentric wheel such that said output shaft extends through said extra washer and said bearing unit for operably coupled with said eccentric holes in said upper and lower eccentric wheels.

7. The hedge trimmer according to claim 1, further comprising a casing defining a motor chamber for receiving said brushless motor therein, said motor chamber having a peripheral wall confining said chamber and being formed with a plurality of heat dissipation holes.
